(19) United States
(12) Patent Application Publication
(10) Pub. No.: US 2025/0059827 A1
(43) Pub. Date: Feb. 20, 2025

(54) Roll Up Door Spring Tensioning Device

(71) Applicant: Roll-Up Door, Inc., Blackshear, GA (US)

(72) Inventors: Keith M. Nakoff, Elizabethton, TN (US); Mario Gurrola, Waycross, GA (US); Ethan A. Ward, Carrollton, GA (US)

(21) Appl. No.: 18/723,420

(22) PCT Filed: Dec. 22, 2022
(86) PCT No.: PCT/US22/53897

§ 371 Date: Jun. 22, 2024

Related U.S. Application Data
(60) Provisional application No. 63/293,058, filed on Dec. 22, 2021.

(51) Int. Cl. E06B 9/60; E05D 13/00

(52) U.S. Cl. CPC E06B 9/60; E05D 13/1253; E05Y 2900/106; E05Y 2900/11

(57) ABSTRACT

A roll up door tensioning device is provided. A bracket having a first door side and a second outer side connects an axle to a support structure. A spring plate on the bracket second outer side has an inner circumference fixedly attached to a collared bearing assembly for rotatably supporting an axle through the bracket. The spring plate is fixedly attached to a tensioning wheel on the bracket first door side. A tensioning wheel on the bracket first door side forms a drive stop mechanism with a tensioning drive.

### CROSS-REFERENCE TO RELATED APPLICATIONS

This application is a U.S. National Stage of International Application No. PCT/US22/53897 filed Dec. 22, 2022 which claims the benefit of U.S. Provisional Patent Application Ser. No. 63/293,058 filed Dec. 22, 2021, all of which are hereby incorporated by reference in their entirety.

### FIELD

This disclosure relates generally to the design, manufacture, and use of spring tensioning devices for roll up doors.

### BACKGROUND

Often, current roll up doors benefit from a counterbalance assembly utilizing counterbalancing spring tensioning to help offset and alleviate the weight of the doors themselves and provide roll up ease for the user as the doors roll up and down between open and closed positions (also referred to as door cycling).

### SUMMARY

According to one aspect of the disclosed subject matter, a roll up door tensioning device is provided. A bracket having a first door side and a second outer side connects an axle to a support structure. A spring plate on the bracket second outer side has an inner circumference fixedly attached to a collared bearing assembly for rotatably supporting an axle through the bracket. The spring plate is fixedly attached to a tensioning wheel on the bracket first door side. A tensioning wheel on the bracket first door side forms a drive stop mechanism with a tensioning drive.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages that are included within this description, be within the scope of any claims.

### BRIEF DESCRIPTION OF THE FIGURES

The features, natures, and advantages of the disclosed subject matter may become more apparent from the detailed description set forth below when taken in conjunction with the drawings in which like reference numerals indicate like features.

FIG. 1 is a diagram showing an exploded perspective view of a roll up door spring tensioning device showing the bracket outer side and having a worm tensioning drive.

FIG. 2 is a diagram showing a perspective view of the roll up door spring tensioning device of FIG. 1 showing the bracket outer side.

FIG. 3 is a diagram showing a perspective view of the roll up door spring tensioning device of FIG. 1 showing the bracket door (i.e., inner) side.

FIG. 4 is the diagram of FIG. 3 showing a tension spring.

FIG. 5 is a diagram showing an enlarged view of a portion of FIG. 3.

FIG. 6 is a diagram showing a side view of the roll up door spring tensioning device of FIG. 1 showing the bracket door side.

FIG. 7 is a diagram showing an enlarged view of a portion of FIG. 6.

FIG. 8 is a diagram showing a side view of the roll up door spring tensioning device of FIG. 1.

FIG. 9 is a diagram showing an enlarged view of a portion of FIG. 2.

FIG. 10 is the diagram of FIG. 2 showing axle 32 through a tension spring.

FIG. 11 is a diagram showing a side view of the roll up door spring tensioning device of FIG. 10.

FIG. 12 is a diagram showing an enlarged view of a portion of FIG. 11.

FIG. 13 is a diagram showing a perspective view of a roll up door spring tensioning device showing the bracket door (i.e., inner) side and having a geneva tensioning drive.

FIG. 14 is a diagram showing a perspective view of the roll up door spring tensioning device of FIG. 13 showing the bracket outer side.

FIG. 15 is a diagram showing a side view of the roll up door spring tensioning device of FIG. 14.

FIG. 16 is a diagram showing a perspective view of a roll up door spring tensioning device showing the bracket outer side and having a ratchet drive.

FIGS. 17 and 18 are diagrams showing a perspective view of the roll up door spring tensioning device of FIG. 16 showing the bracket door (i.e., inner) side without a tension spring.

### DESCRIPTION

The following description is not to be taken in a limiting sense, but is made for the purpose of describing the general principles of the present disclosure. The scope of the present disclosure should be determined with reference to the claims. Exemplary embodiments of the present disclosure may be illustrated in the drawings, like numbers being used to refer to like and corresponding parts of the various drawings. The dimensions of drawings provided are not shown to scale.

The present application provides spring tensioning device innovations for raising (rolling) and lowering (unrolling) roll up doors, notably sheet metal roll up (or rolling) doors for commercial, industrial, garage, and storage applications. For example a door for use in a storage unit or a door for vehicular use at entrances of commercial buildings such as loading docks, service stations, parking garages and manufacturing plants. The solutions described provide both substantially improved roll up door spring tensioning and roll up door installation ease.

The roll up door innovations herein utilize spring torsion and a torsion spring-a type of spring that works by turning one end about a longitudinal axis while the other end is held or turned in the opposite direction, developing torque. An axle (or axel herein) is threaded through the torsion spring. One end of the torsion spring is attached directly or indirectly to the axle such that the rotation of the axle about its axis applies torque to the spring (e.g., for example the spring may be attached to a cylindrical shaped drum through which the axle passes and attached to the axle to rotate—or wind and unwind—with the axle) and the other end is fixed or anchored. As the door is rolled down, torque is increased and increased tension is applied to the spring. And as the door is rolled up, torque is released and decreased tension is applied to the spring. Thus it is easier for a user to roll up the door, doors which are often quite heavy.

Upon attachment of the spring ends-one end to the axle and one end fixed-load is adjusted and applied to the spring. The load of the torsion spring applies to the torque and tension present in the spring when the door is rolled up. Too much spring and the door is too easy to roll up because there is too much spring tension (known as a “hot” spring) and too little spring and door is too heavy to roll up because there is too little spring tension (known as a “cold” spring).

Assembly and spring load customization and adjustability ease are key features and advantages of the present application. Because of variable door sizes, customization including door weight and user desired spring tension, shipping, and logistics reasons, this spring load is applied and may subsequently be adjusted after assembly and installation of the roll up door.

The term fixedly attached is used to refer to an attachment of two parts that does not allow for independent rotation of the two attached parts. The term rotatably attached is used to refer to an attachment of two parts that does allow for independent rotation of the two attached parts.

The following common roll up door terminology is used herein.

Axle: A horizontal member at the head of the opening that supports the curtain (i.e., the roll up door) and which by rotating the roll up door may be raised or lowered (e.g., cycled).

Bracket(s): Hardware used when mounting a roll door above the header or outside the door jamb opening.

Counterbalance Assembly: An assembly consisting of torsion springs, spring anchors, axle, and drum.

Curtain: A number of curtain panels joined together to adequately close off an opening.

Curtain Panel: Formed metal sheet consisting of multiple corrugations with horizontal hems.

Cycle: An action on the door from the fully closed position, to the fully open position, and returned to the fully closed position.

Dead Axle: Axle assembly that remains stationary when the door is operated.

Drum: A cylindrical component attached to the axel, which is used to support the roll diameter of the curtain.

Live Axle: Axle assembly that turns with the door when operated.

Spring Hook: A formed end of the counterbalance spring wire used to facilitate assembly.

Torsion or Tension Spring: A spring that works by turning one end about a longitudinal axis while the other end is held or turned in the opposite direction, developing torque.

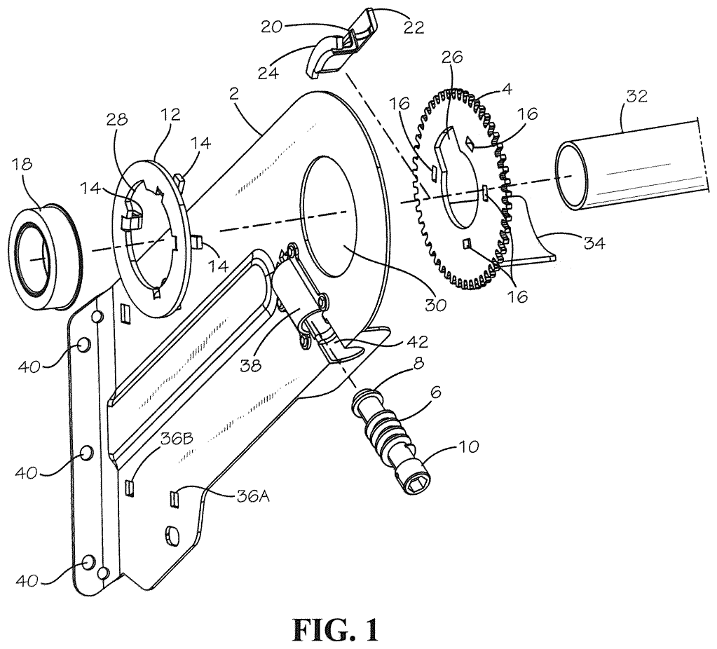

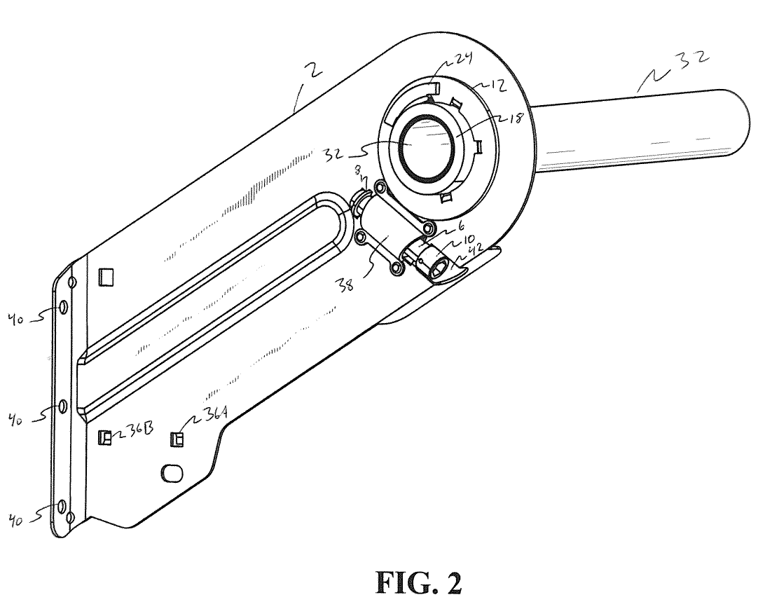

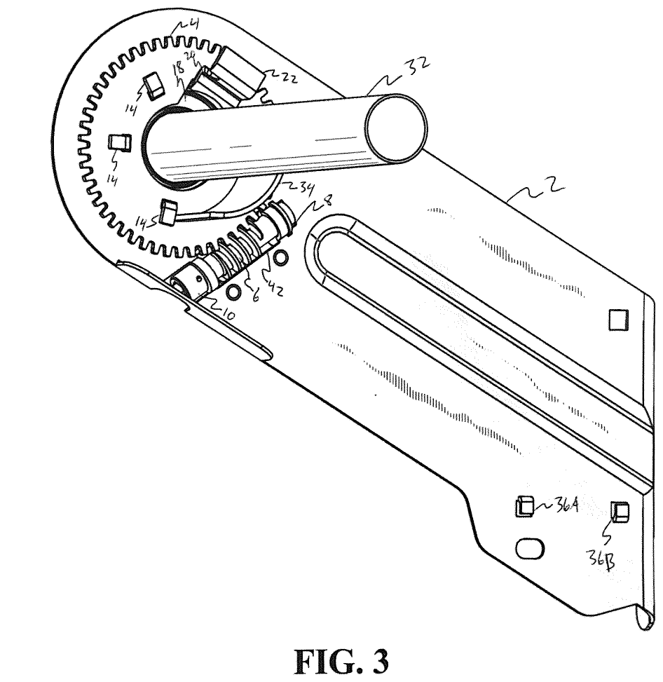

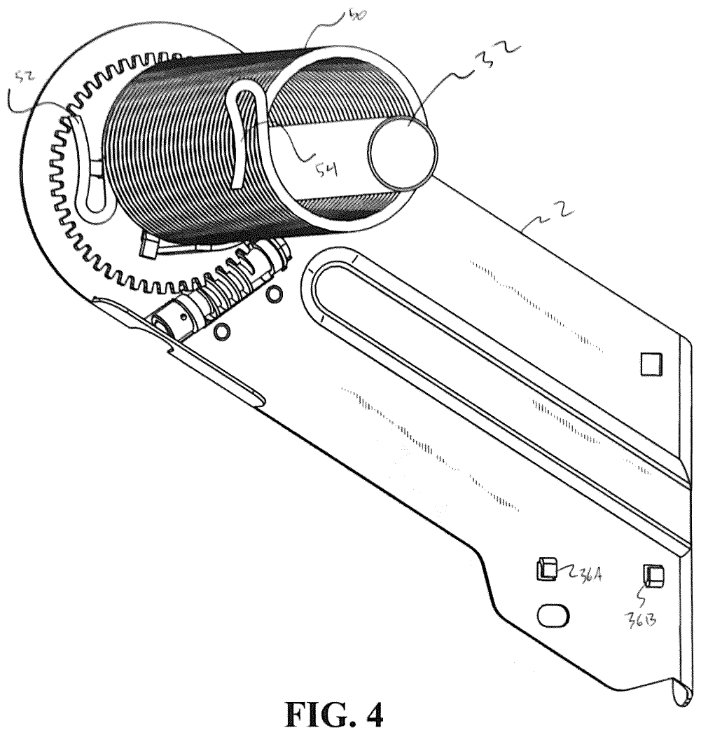

FIG. 1 is a diagram showing an exploded perspective view of a roll up door spring tensioning device showing the bracket outer side and having a worm tensioning drive. FIG. 2 is a diagram showing a perspective view of the roll up door spring tensioning device of FIG. 1 showing the bracket outer side, and FIG. 3 is a diagram showing a perspective view of the roll up door spring tensioning device of FIG. 1 showing the bracket door (i.e., inner) side. FIG. 4 is the diagram of FIG. 3 and showing axle 32 through tension (also called torsion) spring 50 (i.e., tension spring 50 around axel 32).

Tensioning wheel 4 on the door side of bracket 2 and tensioning drive 6 form a worm drive tensioning drive (i.e., tensioning wheel 4 being the worm gear and tensioning drive 6 being the worm screw) for producing intermittent rotary motion, characterized by alternate periods of motion and rest with no reversal in direction. Spring plate tabs 14 attach spring plate 12 positioned on the outer side of bracket 2 to tensioning wheel 4. Axle 32 passes through tensioning wheel 4 and bracket 2.

Spring catch 22 of spring tab 20 catches spring hook 52 of tension spring 50 to anchor or fix spring hook 52 during cycling of the roll up door. Spring guide 34 rests against the inner circumference of tension spring 50 to position tension spring 50 correctly. Door guide tab 36B helps position bracket 2 and common roll up door system components. Spring hook 54 of tension spring 50 is attached to axle 32 (e.g., spring hook 54 is attached to a drum or hook, not shown, surrounding axle 32, thus winding and unwinding during cycling of the roll up door). The tension, or torque, of the tension spring may be adjusted by turning tension bolt 10 of tensioning drive 6, adjustable from the bracket outer side indentation 42 of bracket 2 (e.g., using a hex key in tensioning bolt 10), that rotates/turns tensioning drive 6 and drives tensioning wheel 4.

Spring plate 12 attaches to tensioning wheel 4 using spring plate tabs 14 pushed through prefabricated tensioning wheel holes 16 in tensioning wheel 4. The circumferential hole 30 in bracket 2 through which axle 32 passes is large enough to allow the attachment tabs of spring plate 12 and tensioning wheel 4 to rotate freely. However, the lip of spring plate 12 overlaps onto the bracket outer side, thus being supported by the bracket outer side. This allows spring plate 12 to support tensioning wheel 4 on the bracket door side (via spring plate to tensioning wheel tab connection by spring plate tabs 14 in tensioning wheel holes 16).

Spring tab 20 is positioned through circumferential hole 30 through bracket 2 and is fixedly attached to spring plate 12 (e.g., connection tab 24 of spring tab 20 positioned through spring tab indentation 28 of spring plate 12 and welded to spring plate 12). Spring catch 22 of spring tab 20 is positioned through indentation 26 of tension wheel 4 and connected to tension wheel 4 such that spring catch 22, and thus spring tab 20, rotates with tension wheel 4 but may be pulled apart from tension wheel 4. A rotable connection advantageous for safety and assembly. Spring tab 20 may be fixedly attached to spring plate 6 or tensioning wheel 4.

Tension load may be applied to tension spring 50 upon attaching spring hook 52 of tension spring 50 to axle 32 by fixing axle 32 and turning tension bolt 10 that turns tension drive 6 that turns tension wheel 4 and spring catch 22 which catches spring hook 52 of tension spring 50. The appropriate spring tension desired is achieved by turning tension bolt 10, thus setting tension drive 6 and the spring tension of tension spring 50. During roll up door cycling (i.e., rolling the door around axle 32 and thus moving the door up and down), tension spring 50 provides counterbalancing tension allowing less force—and thus making it easier—to roll the door up. Tension adjustments are easily made and set by turning tensioning drive 6 by turning tension bolt 10 either way.

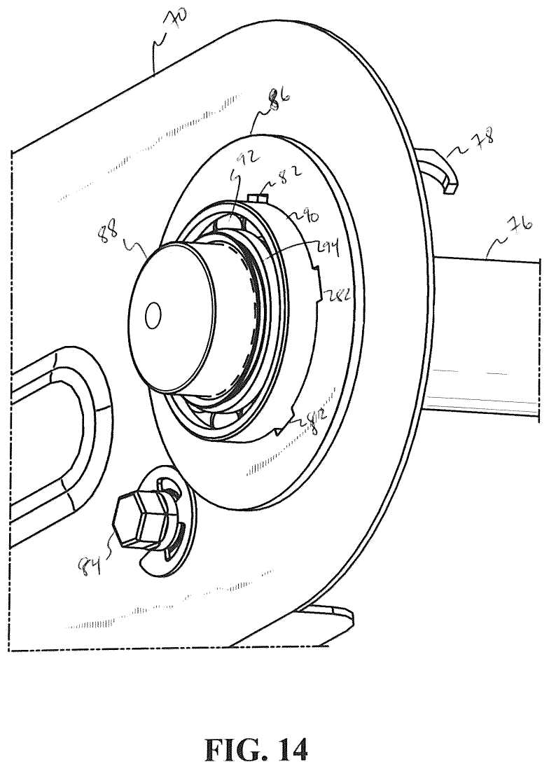

Collared bearing assembly 18, a collared ball bearing assembly, supports and allows for the rotation of axle 32. Collared bearing assembly advantageously comprises ball bearings housed between an inner and outer collar (such as inner collar 94 and outer collar 90 housing bearings 92 readily shown in FIG. 14). The collared bearing assembly is fixed within a hole (circumferential hole 30) through bracket 2. Collared bearing assembly 18 is fixed to spring plate 12—advantageously stakedly fixed or “staked.” Tensioning drive 6 (i.e. the worm screw) rotates/turns tensioning wheel 4 (i.e. the worm wheel or gear) to form a worm drive Head stop tab 36A helps position bracket 2 and common roll up door system components. Bracket 2 is secured to and supported by a support structure, such as a door jamb, by bolting bracket 2 through bolt holds 40 to the support structure above the header to mount, raise (roll), and lower (unroll) the roll up door.

In operation, a rotatable structure through circumferential hole 30 of bracket 2 is formed of spring plate 14, spring tab 20, and tensioning wheel 4 that is driven/rotated by tensioning drive 6. The outer collar of a collared bearing assembly rotates as well when adjusting the tensioning wheel (e.g., when turning the tensioning drive worm screw that turns the tensioning wheel worm gear).

The worm drive is a drive stop mechanism that provides for no reversal of direction of the spring tensioning wheel. The roll up door spring tensioning device of FIG. 1 shows a worm drive. The gear wheel provides torque to the tension spring by turning one end of the tension spring while the other spring tension end remains fixed. The tensionsing wheel of FIG. 1 is a gear wheel, tensioning wheel 4, and the tensioning drive is a worm screw, tensioning drive 6. The tensioning drive adjustment that adjusts the tension of the tension spring is tension bolt 10, adjustable from the bracket outer side, that rotates/turns worm screw 6 and thus adjusts the tension/torque of tension spring 50.

Tension bolt 6 is positioned in indentation 42 of bracket 2 and held in place by straight thread 8 positioned within bracket 2 (straight threads above and below the threads of tensioning drive 6 acting as keeper tabs to hold, or keep, the worm screw in place in the bracket), drive plate 38 riveted to the outside of bracket 2, and tensioning wheel 4.

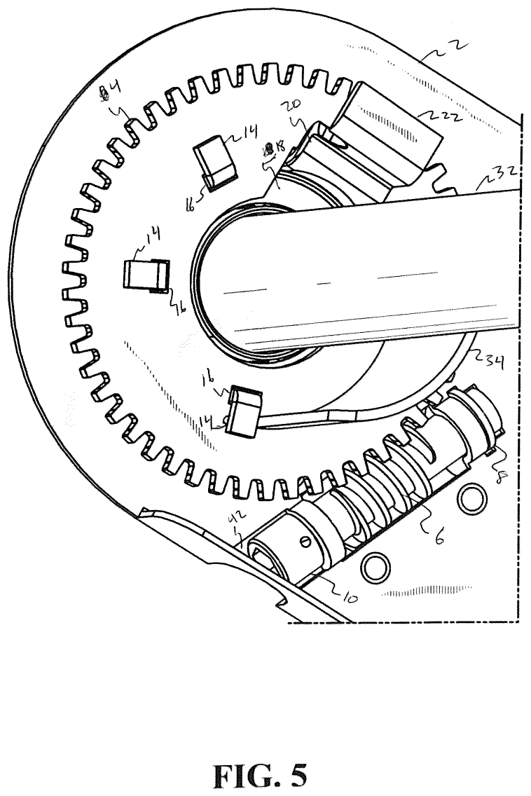

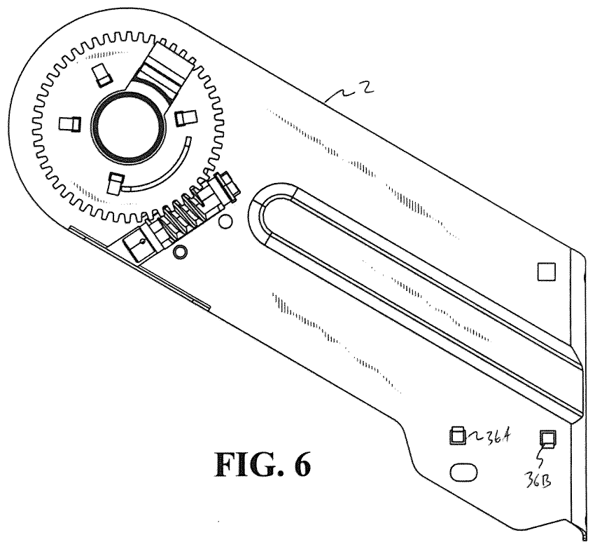

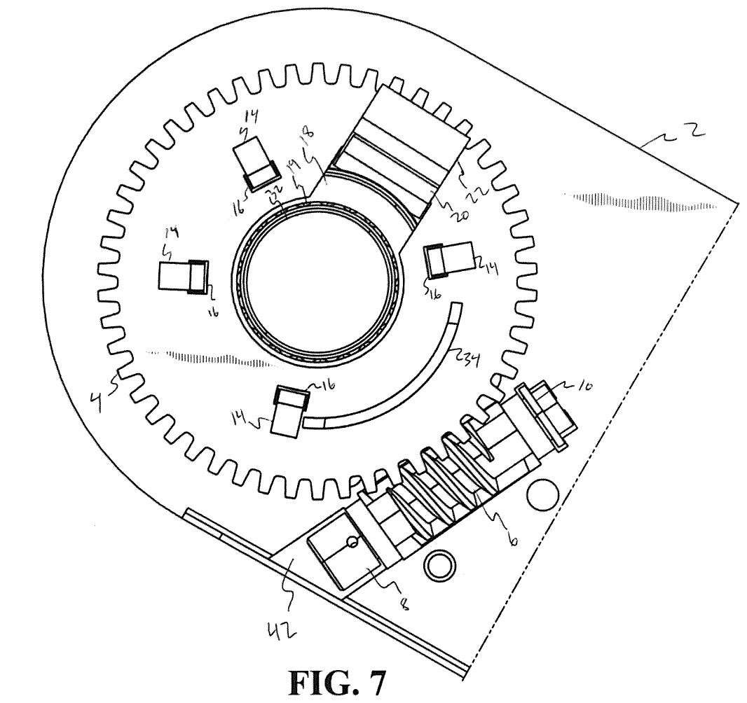

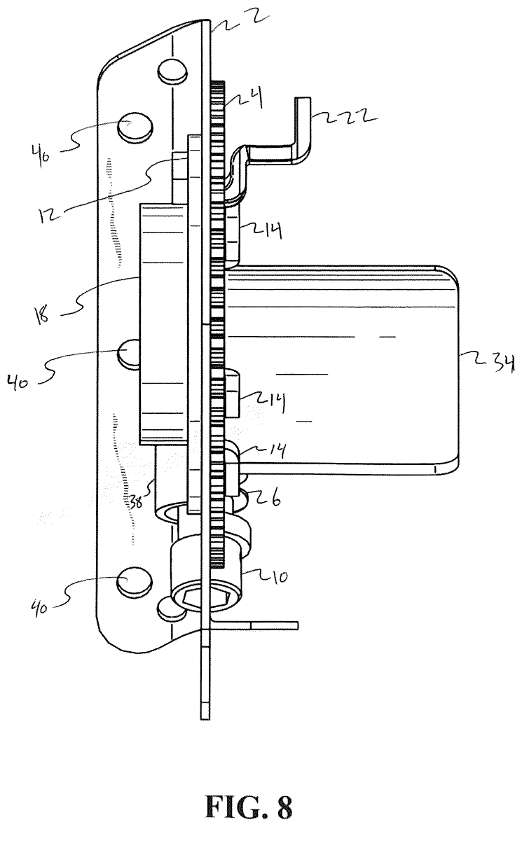

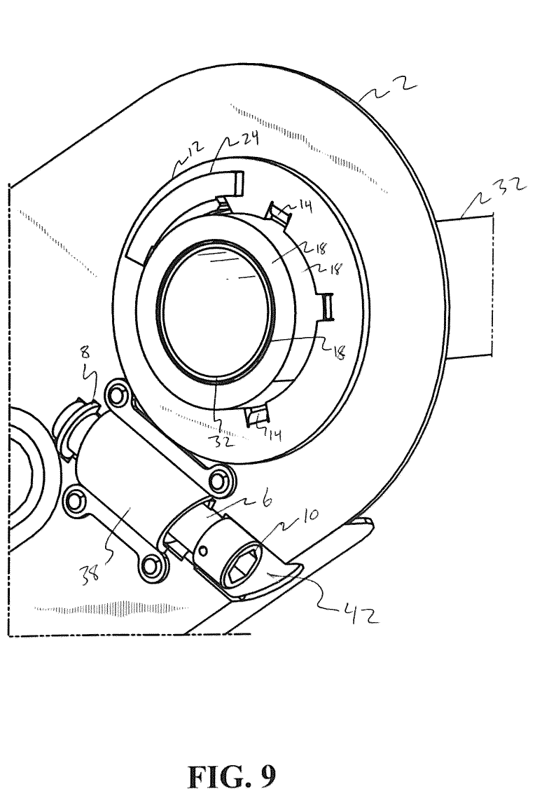

FIG. 5 is a diagram showing an enlarged view of a portion of FIG. 3. FIG. 6 is a diagram showing a side view of the roll up door spring tensioning device of FIG. 1 showing the bracket door side. FIG. 7 is a diagram showing an enlarged view of a portion of FIG. 6. FIG. 8 is a diagram showing a side view of the roll up door spring tensioning device of FIG. 1. FIG. 9 is a diagram showing an enlarged view of a portion of FIG. 2.

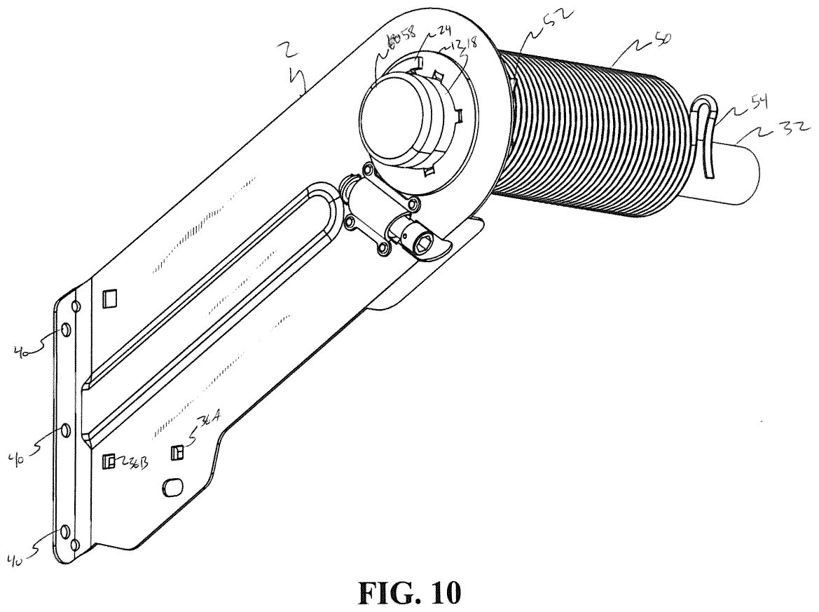

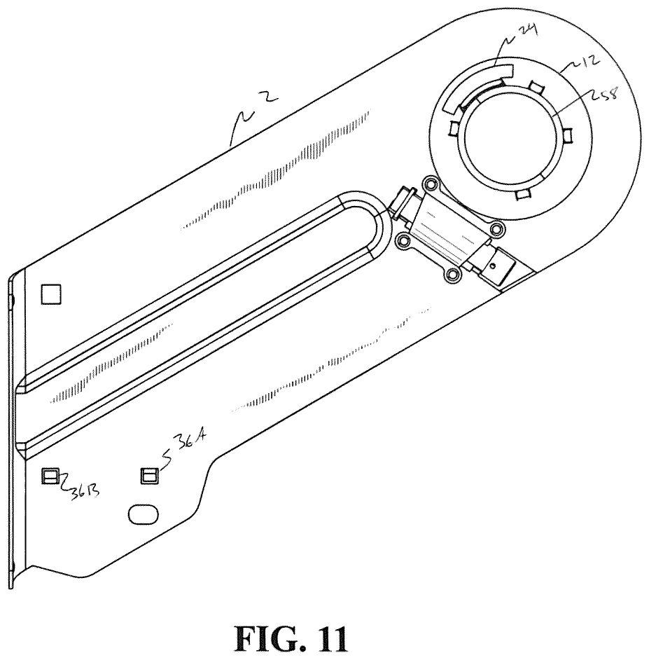

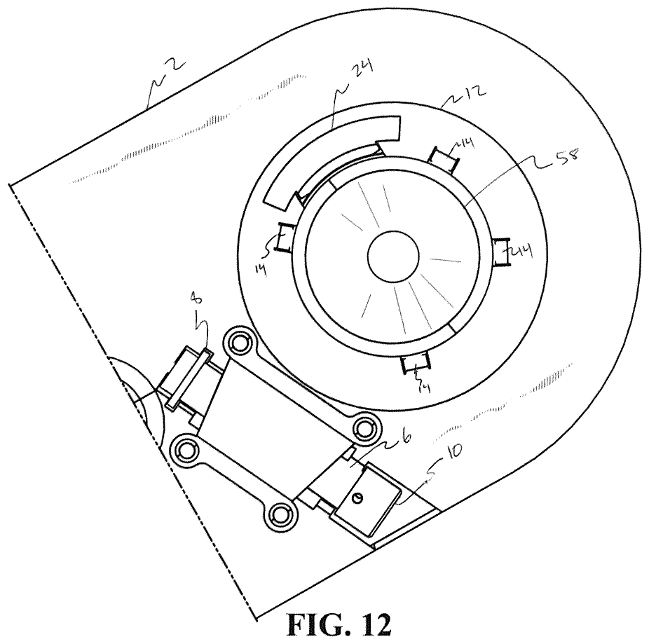

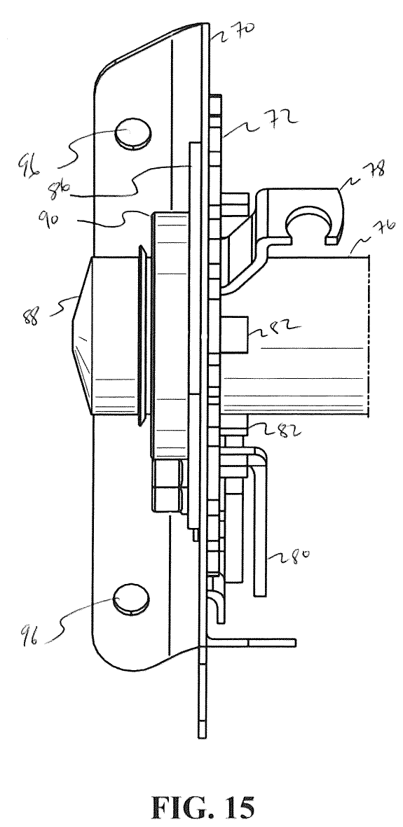

FIG. 10 is the diagram of FIG. 2 and showing axle 32 through tension (also called torsion) spring 50 (i.e., tension spring 50 around axel 32) and having end cap 58 capping axle 32. End cap 58 helps secure axle 32 in bracket 2 and may also comprise a cylindrical spring clip such as that readily shown in FIG. 15. FIG. 11 is a diagram showing a side view of the roll up door spring tensioning device of FIG. 10. FIG. 12 is a diagram showing an enlarged view of a portion of FIG. 11.

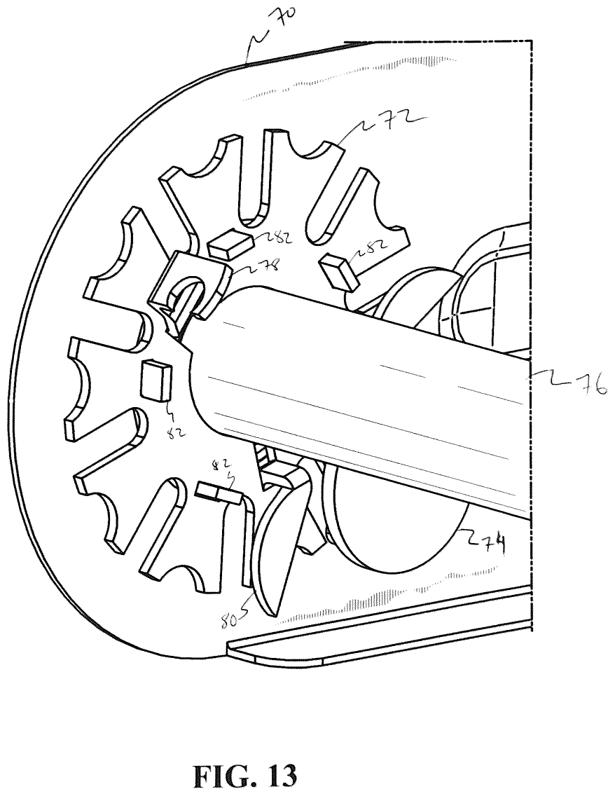

A geneva mechanism may also be a drive stop mechanism that provides for no reversal of direction of the spring tensioning wheel. The spring tensioning wheel provides torque to the tension spring by turning one end of the tension spring while the other spring tension end remains fixed. FIG. 13 is a diagram showing a perspective view of a roll up door spring tensioning device showing the bracket door (i.e., inner) side and having a geneva tensioning drive instead of a worm tensioning drive. The tensionsing wheel of FIG. 13 is geneva wheel 72 and the tensioning drive is drive wheel 74. The tensioning drive adjustment that adjusts the tension of the tension spring is tension bolt 84.

FIG. 14 is a diagram showing a perspective view of the roll up door spring tensioning device of FIG. 13 showing the bracket outer side. FIG. 15 is a diagram showing a side view of the roll up door spring tensioning device of FIG. 14.

Geneva wheel 72 and drive wheel 74 on the door side of bracket 70 form a geneva mechanism (also called a geneva stop, geneva wheel 72 rotates under drive wheel 74) for producing intermittent rotary motion, characterized by alternate periods of motion and rest with no reversal in direction. Spring plate tabs 82 of spring plate 86 positioned on the outer side of bracket 70 attach to geneva wheel 72. Axle 76 passes through geneva wheel 72 and bracket 70. Geneva wheel spring catch 78 catches the spring hook of the tension spring (not shown) to anchor or fix the spring hook during cycling of the roll up door. Geneva wheel spring guides 80 rest against the inner circumference of the tension spring to position the tension spring correctly. The tension spring is attached to axle 76 (e.g., a spring hook is attached to a drum surrounding axle 76, thus winding and unwinding during cycling of the roll up door). The tension, or torque, of the tension spring may be adjusted by turning tension bolt 84, adjustable from the bracket outer side, that rotates/turns drive wheel 74.

A staked collared ball bearing assembly of inner collar 94 and outer collar 90 together housing bearings 92, supports and allows for the rotation of axle 76.

End cap 88 with a cylindrical spring clip secures axle 76 from pulling out of bracket 70 from exterior side to door side and may also clamp/secure spring plate 86 to geneva wheel 72.

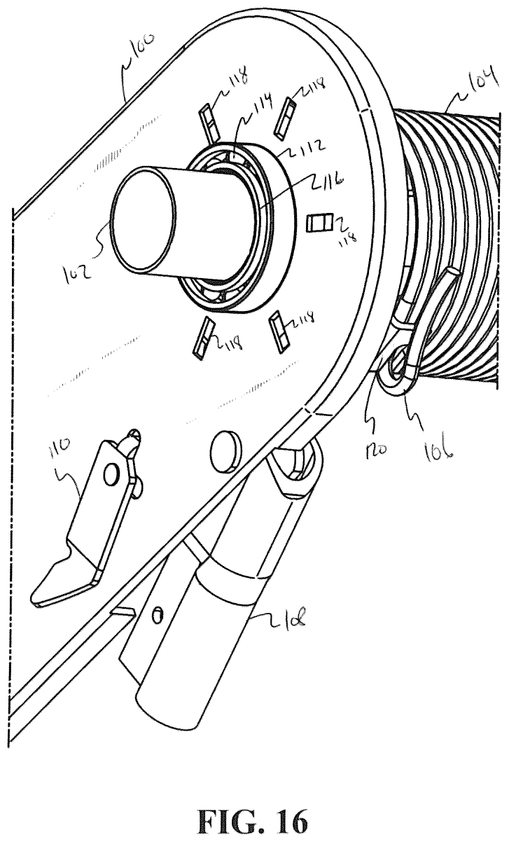

A ratchet assembly may also be a drive stop mechanism that provides for no reversal of direction of the spring tensioning wheel. The roll up door spring tensioning device of FIG. 16 shows a ratchet assembly.

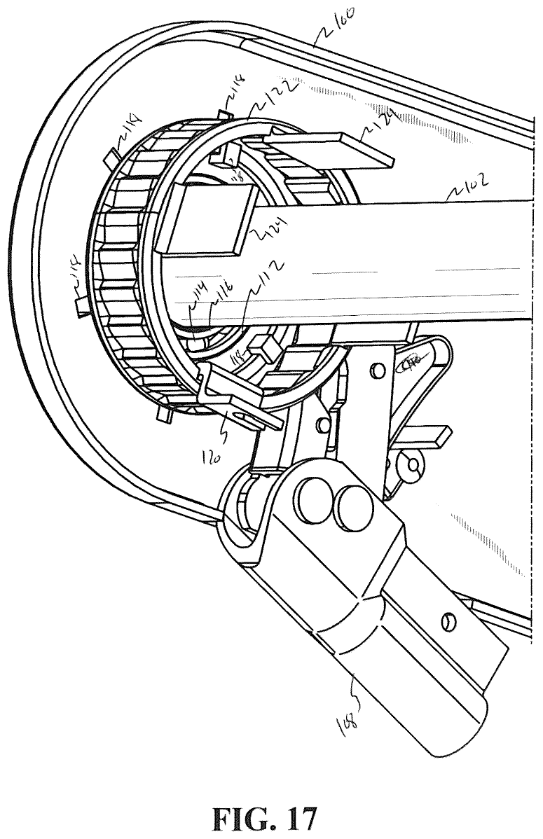

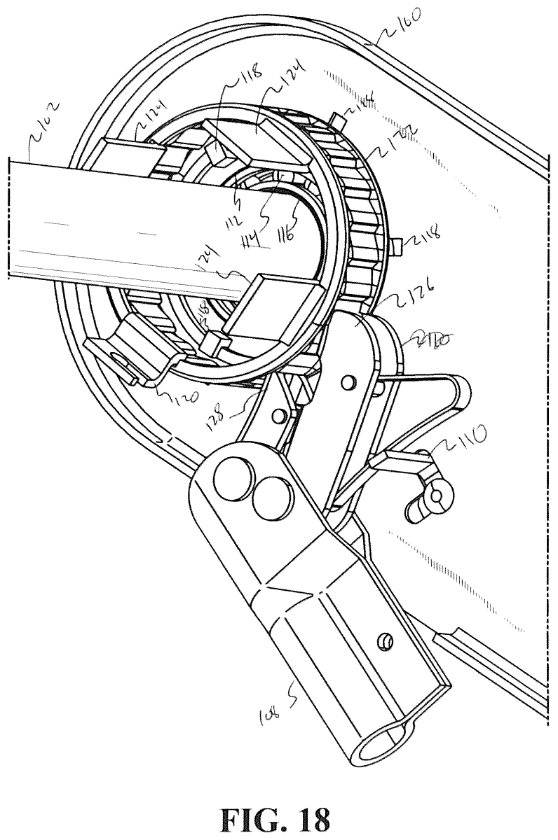

FIG. 16 is a diagram showing a perspective view of a roll up door spring tensioning device showing the bracket outer side and having a ratchet drive. FIGS. 17 and 18 are diagrams showing a perspective view of the roll up door spring tensioning device of FIG. 16 showing the bracket door (i.e., inner) side without tension spring 104 around axle 102.

Spring tab 120 of ratchet catch 122 catches spring hook 106 of tension spring 104 to apply or release (i.e., adjust) tension and torque to tension spring 104 using ratchet assembly tension lever 108 operating pawl 126 and pawl 128 on ratchet catch 122. Ratchet catch 122 is attached to bracket 100 by bracket attachment tabs 118 of bracket 100. The direction of the ratchet assembly may be changed by directional switch 110. A staked collared ball bearing assembly of inner collar 116 and outer collar 112 together housing bearings 114, supports and allows for the rotation of axle 102. Ratchet catch spring guides 124 rest against the inner circumference of the tension spring to position the tension spring correctly.

The foregoing description of the exemplary embodiments is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A roll up door tensioning device, comprising:
a bracket for connecting an axle to a support structure, said bracket having a first door side and a second outer side;
a spring plate on said bracket second outer side, said spring plate having an inner circumference fixedly attached to a collared bearing assembly for rotatably supporting an axle through said bracket, said spring plate fixedly attached to a tensioning wheel on said bracket first door side; and,
said tensioning wheel on said bracket first door side forming a drive stop mechanism with a tensioning drive.

2. The roll up door tensioning device of claim 1, wherein said tensioning wheel and said tensioning drive form a worm drive.

3. The roll up door tensioning device of claim 1, wherein said tensioning wheel and said tensioning drive form a geneva mechanism.

4. The roll up door tensioning device of claim 1, wherein said spring plate is fixedly attached to said tensioning wheel through tabs of said spring plate through said tensioning wheel.

5. A roll up door tensioning device, comprising:
a bracket for connecting an axle to a support structure, said bracket having a first door side and a second outer side;
a spring plate on said bracket second outer side, said spring plate having an inner circumference fixedly attached to a collared bearing assembly for rotatably supporting an axle through said bracket, said spring plate fixedly attached to a tensioning wheel on said bracket first door side;
said tensioning wheel on said bracket first door side forming a drive stop mechanism with a tensioning drive on said bracket first door side; and,
a tension bolt adjustable from said bracket second outer side for turning said tensioning drive.

6. The roll up door tensioning device of claim 5, wherein said tensioning wheel and said tensioning drive form a worm drive.

7. The roll up door tensioning device of claim 5, wherein said tensioning wheel and said tensioning drive form a geneva mechanism.

8. The roll up door tensioning device of claim 5, wherein said spring plate is fixedly attached to said tensioning wheel through tabs of said spring plate through said tensioning wheel.

9. A roll up door tensioning device, comprising:
a bracket for connecting an axle to a support structure, said bracket having a first door side and a second outer side;
a spring plate on said bracket second outer side, said spring plate having an inner circumference fixedly attached to a collared bearing assembly, said spring plate fixedly attached to a tensioning wheel on said bracket first door side;
said tensioning wheel on said bracket first door side forming a drive stop mechanism with a tensioning drive on said bracket first door side;
a tension bolt adjustable from said bracket second outer side for turning said tensioning drive;
an axle through said bracket and rotatably supported by said collared bearing assembly; and,
a torsion spring around said axle, a first end of said torsion spring attached to said tensioning wheel and a second end of said torsion spring attached to said axle.

10. The roll up door tensioning device of claim 9, wherein said tensioning wheel and said tensioning drive form a worm drive.

11. The roll up door tensioning device of claim 9, wherein said tensioning wheel and said tensioning drive form a geneva mechanism.

12. The roll up door tensioning device of claim 9, wherein said spring plate is fixedly attached to said tensioning wheel through tabs of said spring plate through said tensioning wheel.
